(19) United States
(12) Patent Application Publication
(10) Pub. No.: US 2009/0198994 A1
(43) Pub. Date: Aug. 6, 2009

(54) UPDATED SECURITY SYSTEM

(75) Inventor: Teewoon Tan, Roseville (AU)

Correspondence Address: MICHAEL MOLINS;MOLINS & CO., SUITE 5, LEVEL 6, 139 MACQUARIE ST, SYDNEY NSW, 2000, AU

(73) Assignee: Encassa Pty Ltd, Pyrmont NSW (AU)

(21) Appl. No.: 12/365,167

(22) Filed: Feb. 3, 2009

(30) Foreign Application Priority Data
Feb. 4, 2008 (AU) 2008900522
Apr. 29, 2008 (AU) 2008902083

(51) Int. Cl. H04L 9/00; G06F 21/00

(52) U.S. Cl. 713/150; 726/1

(57) ABSTRACT

A method is provided for improving computer security. A computer executes instructions for protecting a processing component on itself. Software generates a second processing module attacher responsive to an execution of the processing component. The computer stores data indicative of at least one second processing module thereby to define a processing module library. The attacher is adapted to retrieve a second processing module from the processing module library and to attach the retrieved second processing module to the processing component. This enables a security restriction on data processed by the processing component.

### FIELD OF THE INVENTION

The present invention relates to security technologies and in particular to security software and methods for protecting a processing component on a client computer.

The invention has been developed primarily for use as security software for enabling a security restriction—on data processed by a processing component—against malware and/or a malicious user attacking, exploiting, spying and controlling a client computer, and will be described hereinafter with reference to this application. Depending on the context,

### BACKGROUND OF THE INVENTION

Australian Provisional Patent Application numbers 2007901297, 2008900522 and 2008901952 are incorporated herein by reference.

Typically anti-virus and anti-spyware solutions rely on signatures to detect the presence of or the operational behaviour of malware. A disadvantage with these techniques is that they rely on the availability of reliable signatures. It is therefore possible that a malware instance is undetected by or ‘slips through’ these solutions because an effective signature for that malware is not available. Once installed, the malware may then steal, destroy and/or alter data on the compromised computer system. The installed malware may also enable external control of the computer system through backdoors by sending and receiving remote commands. The malware may also propagate to other computer systems.

Attackers, for example disgruntled employees, may also reside within an organisation. So there is a need for security mechanisms that protect valuable data and information from internal attackers. Typically this is addressed by security strategy that includes policies, procedures, and practices.

There is a need in the art for a security software to protect a processing component on a client computer, and enable a security restriction on data processed by the processing component. The present invention is an improvement on the inventions disclosed in Australian Provisional Patent Application numbers 2007901297 and 2008900522, which are incorporated herein by reference.

Any discussion of the prior art throughout the specification should in no way be considered as an admission that such prior art is widely known or forms part of the common general knowledge in the field.

### OBJECT OF THE INVENTION

It is an object of the present invention to overcome or ameliorate at least one of the disadvantages of the prior art, or to provide a useful alternative.

It is an object of the invention in its preferred form to provide security software or method to protect a processing component on a client computer, and to enable a security restriction on data processed by the processing component.

### SUMMARY OF THE INVENTION

In one embodiment, there is provided, a method for improving computer security, the method causing a computer to execute instructions for protecting a processing component on itself the method comprising steps stored in a memory for: generating a second processing module attacher adapted to be responsive to an execution of the processing component, storing data indicative of at least one second processing module thereby to define a processing module library, wherein the attacher is adapted to retrieve a second processing module from the processing module library in response to the execution of the processing component, and wherein the attacher is further adapted to attach a retrieved second processing module to the processing component, thereby to enable a security restriction on data processed by the processing component.

The invention also provides, in some embodiments, a computer-readable medium carrying a set of instructions that when executed by one or more processors cause the one or more processors to carry out a method of protecting a processing component on a client computer, the method comprising the steps of: retrieving, in response to program execution of the processing component, at least one second processing module from a processing module library; and attaching the retrieved second processing module to the processing component, thereby to apply enable security restrictions to data processed by the processing component.

According to other aspects of the invention there is provided security software to protect a processing component on a client computer. The security software comprises instructions adapted to implement the methods of the present invention.

According to a second aspect of the invention there is provided a method of protecting a processing component on a client computer. The method preferably comprises the steps of:
retrieving, in response to program execution of the processing component, at least one second processing module from a processing module library; and
attaching the retrieved second processing module to the processing component, thereby to enable security restrictions to data processed by the processing component.

According to a third aspect of the invention there is provided a computer-readable carrier medium carrying a set of instructions that when executed by one or more processors cause the one or more processors to carry out a method of protecting a processing component on a client computer as described herein.

According to a further aspect of the invention there is provided a protection modules provider coupleable via transmission medium to at least one client computer comprising security software—as defined herein. Preferably the protection modules provider comprises:
a protection module creator adapted to receive processing component information and to provide a protection module that comprises data indicative of a processing module and a module data;
wherein the protection module provider is adapted to store the created protection module thereby to define a protection module library; and
a protection module server adapted to supply a protection module to the security software.

According to a further aspect of the invention there is provided a method of providing a protection module to at least one client computer comprising the steps of:
providing processing component information;
creating a protection module using the processing component information;
storing the protection module to define a protection module library;
obtaining the protection module from the protection module library; and
supplying the protection module to the security software.

### BRIEF DESCRIPTION OF THE DRAWING FIGURES

The invention may be better understood with reference to the illustrations of embodiments of the invention which:

FIG. 1 depicts a schematic view of the data flow of one embodiment of the present invention,

FIG. 2 depicts a schematic view of the data flow of one embodiment of the present invention,

FIG. 3 depicts a schematic view of the data flow of one embodiment of the present invention,

FIG. 4 depicts a schematic view of the data flow of one embodiment of the present invention,

FIG. 5 depicts a flowchart outlining the steps involved in creating and storing a protection module in one embodiment of the present invention,

FIG. 6 depicts a flowchart outlining the steps involved in updating protection modules in a security system and/or security software in one embodiment of the present invention,

FIG. 7 depicts a flowchart outlining the steps involved in protecting input data from malware where a user supplies the input data in one embodiment of the present invention,

FIG. 8 depicts a flowchart outlining the steps involved in attaching a second processing module to a running process in one embodiment of the present invention,

FIG. 9 depicts a schematic view of the data flow of one embodiment of the present invention,

FIG. 10 depicts a schematic view of the data flow of one embodiment of the present invention,

FIG. 11 depicts a schematic view of the data flow of one embodiment of the present invention,

FIG. 12 depicts a schematic view of the data flow of one embodiment of the present invention, and

FIG. 13 depicts a schematic view of the data flow of one embodiment of the present invention.

### BEST MODE AND OTHER EMBODIMENTS OF THE INVENTION

The present invention discloses a security software system and method for using protection modules to protect processing components. The protection of processing components also refers to the protection of data they receive/generate and the enforcement of policies governing their access to particular resources.

According to an embodiment, security software and method can enable protection to a processing component on a client computer. The security software is adapted to attach a processing module to the processing component, thereby to enable a security restriction on data processed by the processing component. The attached processing module can be adapted to be executed within the process space of (and/or in conjunction with) the processing component, thereby enabling enforcement of a security policy governing access to a client computer resource and/or data element.

Protection modules can be used to facilitate simplified updates of a security system (or security software) to protect a processing component. Processing components can be protected without requiring modifications to the source code of the processing components, or requiring the processing components to be extensible through the use of an appropriate architecture, such as those supporting the use of plug-ins and the like. In an embodiment, protection modules can be automatically distributed and installed on security software systems on a regular basis to provide protection for additional processing components. This update facility can be made available to users of the security software systems on a subscription arrangement. Merely by way of example, a user may pay an annual subscription fee to receive regular protection module updates for use on their licensed version of the security systems (or security software).

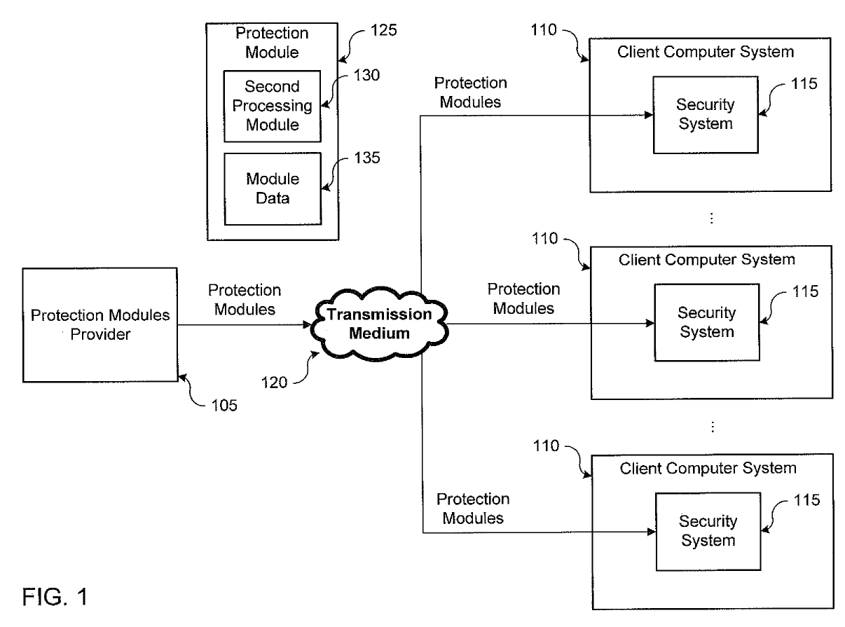

Referring to FIG. 1, an embodiment of the present invention can comprise a protection module provider 105, a plurality of client computer systems 110, a security system (or security software) 115 in each client computer system 110, and a transmission medium 120. The protection modules provider 105 is coupled to the transmission medium 120, and each of the client computer systems 110 is coupled to the transmission medium 120. It will be appreciated that a transmission medium 120 can include, but is not limited to, one or more of the set comprising: the Internet, a local area network, a wireless network, a wide area network, a metropolitan area network, a null-modem connection, a PCI bus, a HyperTransport bus, and a computer's internal data bus.

Protection modules provider 105 supplies protection modules 125 to each security software system 115 via transmission medium 120. Each protection module 125 comprises a second processing module 130 and module data 135. Security software system 115 protects processing components on the client computer system 110 from malware by using data provided in protection modules 125. A protection modules provider 105 may serve a plurality of security software systems 115. In one embodiment, different protection modules may be delivered to different client computer systems.

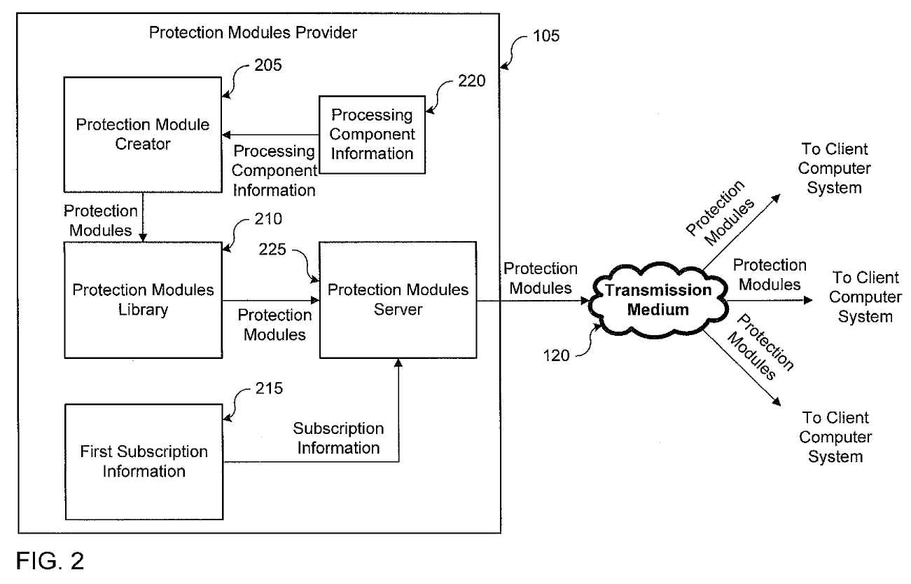

FIG. 2 further illustrates an embodiment of a protection modules provider 105. The protection modules provider 105 comprises protection module creator 205, processing component information 220, protection modules library 210, protection modules server 225, and first subscription information 215.

In an embodiment, as best shown in FIG. 1, a protection modules provider 105 is coupleable via transmission medium 120 to at least one client computer 110 comprising a security system (or security software) 115. Referring to FIG. 2, the protection modules provider can comprise:
a protection module creator 205 adapted to receive processing component information 220 and to provide a protection module 125 that comprises a second processing module 130 and module data 135 (as best shown in FIG. 1);
wherein the protection module provider is adapted to store the created protection module thereby to define a protection module library 210; and
a protection module server 225 adapted to supply a protection module to the security software 115.

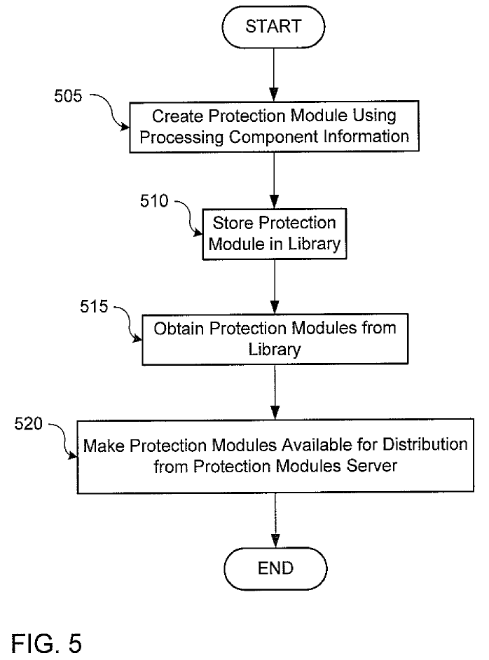

The following description of a procedure of creating a protection module also makes references to the flowchart in FIG. 5.

In an embodiment, a method of providing protection modules to at least one client computer 110 comprising security software 115, can comprise the steps of:
providing processing component information;
creating a protection module using the processing component information 505;
storing the protection module in a protection module library 510;
obtaining the protection module from the protection module library 515; and
supplying the protection module to the security software 520.

By way of example, a protection module creator 205 creates protection modules 125 that can be used by security software 115 for protecting one or more processing components. As described by step 505 in FIG. 5, a protection module 125 is created by using processing component information 220 during a creation operation, where processing component information 220 comprises information on a processing component to be protected. A second processing module 130 and module data 135 provided in a protection module 125 is created for a specific processing component using information about that processing component as supplied by processing component information 220. In an embodiment, the creation of a protection module 125 using protection module creator 205 can involve human assistance where programming code is written and compiled to form at least part of a second processing module 130 and/or at least part of module data 135.

Merely by way of example, processing component information 220 may include information such as software application version, software application name, software application vendor, software application family, how input/output (I/O) data is processed by the running application, which operating system I/O handling functions are used during the processing of I/O data, and policies governing access to particular resources. Processing component I/O handling functions include operating system I/O handling functions. For example, a running process typically processes I/O data by calling one or more operating system I/O handling functions. Since these operating system functions are executed by the running process, these functions can be considered to be a part of the running processes' I/O handling functions. Examples of operating system I/O handling functions include the Microsoft Windows Win32 API functions PeekMessageA, PeekMessageW, GetMessageA, GetMessageW, CreateFile, ReadFile, WriteFile, WSASocket, socket, connect, bind, accept, listen, and other Win32 API functions that may handle, receive, and/or transmit input data. Examples of other I/O handling functions include C programming language runtime library functions, such as read, write, fopen, and fgets.

In step 510 of FIG. 5, the created protection modules 125 are stored in protection modules library 210. Protection modules library 210 maintains a collection of one or more protection modules 125. In one embodiment, protection modules library 210 is a directory on a storage device, such as a hard disk, and the directory comprises individual files, where each protection module 125 is a file. In another embodiment, protection modules library 210 is an SQL database, where protection modules 125 are stored in this SQL database.

In step 515 of FIG. 5, protection modules server 225 obtains protection modules 125 from the protection modules library 210, and makes it available for distribution in step 520. Protection modules server 225 accesses the protection modules library 210, and provides one or more protection modules 125 to one or more security software systems 115 via transmission medium 120 and client computer systems 110. In one embodiment, the protection modules server 225 reads the first subscription information 215 to obtain subscription information for a security software system 115. In this embodiment, the protection modules server 225 only provides a protection module 125 to a security software system 115 if the transmission is allowed by the first subscription information 215.

Merely by way of example, first subscription information 215 includes the expiry date of the annual subscription of a security software system 115 to the protection modules update service. If the current date is before the expiry date, then protection modules server 225 delivers protection module updates to the corresponding security software system 115. Otherwise, the protection modules server 225 does not deliver the protection module updates.

Protection module updates include new protection modules and replacement protection modules for existing protection modules. Replacement protection modules are newer versions of existing protection modules that are released to add new features or fix errors. In one embodiment, protection module updates are fully automatic from the standpoint of a user of the security software system 115. That is, the security software system 115 automatically downloads protection modules from the protection modules provider 105, installs the protection modules and makes use of the new/replacement protection modules without user intervention.

In one embodiment, protection modules server 225 is provided by a separate computer system to the one hosting the other components of the protection modules provider 105. That is, the protection modules provider 105 may be provided by a plurality of computer systems. Merely by way of example, the protection modules server 225 may be a web server and another computer system is used to create and store the protection modules 125. Once protection modules 125 are created, they are uploaded to the web server and made ready for distribution to security software systems 115. Another computer system may comprise the first subscription information 215.

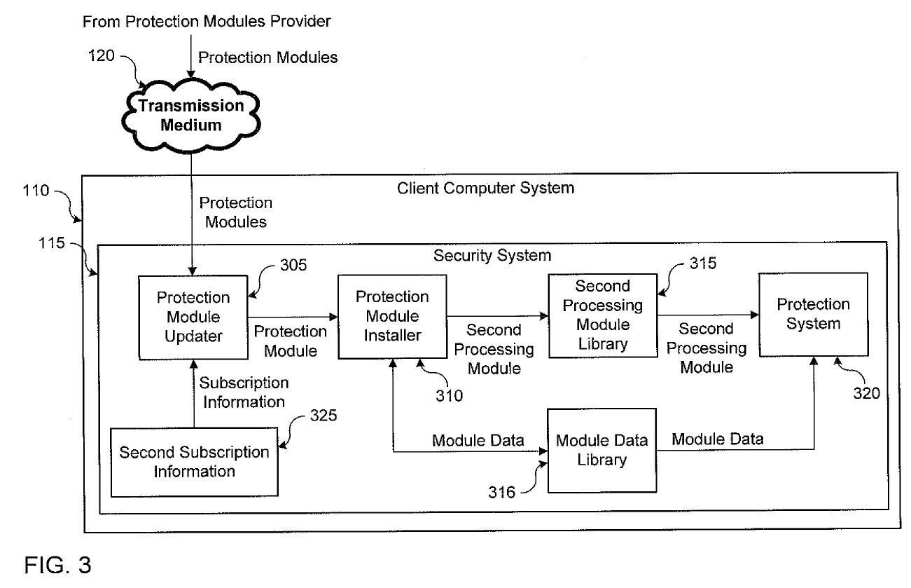

FIG. 3 illustrates an embodiment of a security system (or security software) 115. The security software system 115 comprises a protection module updater 305, a protection module installer 310, a second processing module library 315, a module data library 316, a protection system 320, and a second subscription information 325.

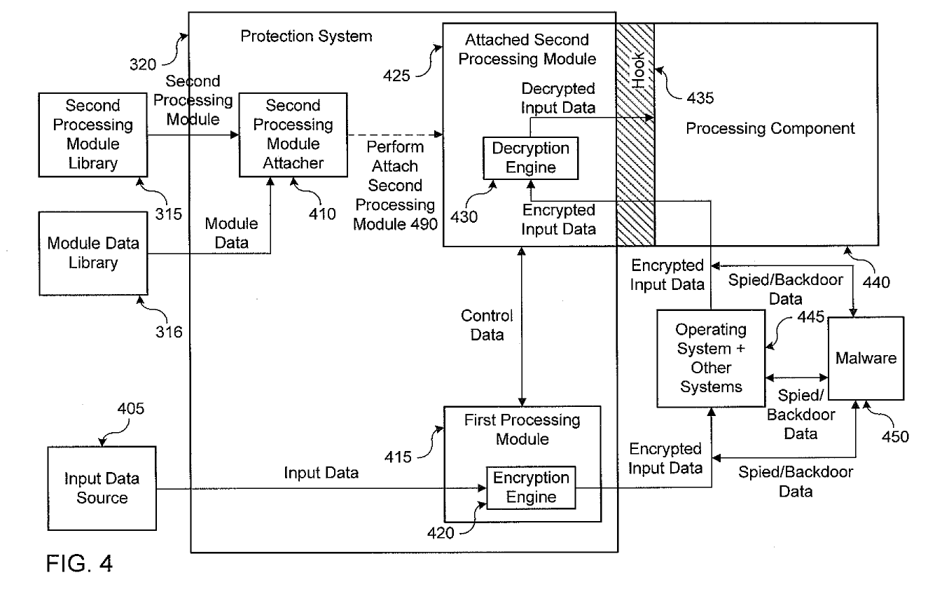

In an embodiment, security software 115—to protect a processing component on a client computer 110—can comprise:
a processing module attacher 410 (included in the protection system 320) responsive to the processing component 440 execution, as best shown in FIG. 4;
wherein the security software is adapted to store data indicative of at least one second processing module thereby to define a processing module library 315;
wherein the attacher is adapted to retrieve a second processing module 425 from the processing module library in response to the processing component execution;
wherein the attacher is further adapted to attach a retrieved second processing module to the processing component, thereby to enable a security restriction on data processed by the processing component.

In this example, the retrieved second processing module 425 is preferably selected from the processing module library as a predetermined response to the execution of respective processing component. The attached processing module 425 is also preferably adapted to be executed within the process space of, and/or in conjunction with, the processing component 440; thereby enabling enforcement of a security policy governing access to a client computer resource and/or data element.

The protection system 320 can wait for the processing component 440 to start executing. Upon execution of the processing component, the protection system 320 can determine if an appropriate second processing module is stored in the processing module library; and, if the appropriate processing module is stored, modifying the executing processing component with the second processing module using the second processing module attacher 410.

Installed security software can, by way of example only, generate or implement:
a protection module installer 310 adapted to receive a protection module including data indicative of the processing module and module data;
   wherein the module installer is further adapted to store the data indicative of the processing module in the processing module library 315;
   and store the data indicative of module data in a module data library 316; and
a protection module updater 305 adapted to receive the protection module from a protection modules server via a transmission medium 120;
   wherein the protection module updater is further adapted to transfer the protection module data to the protection module installer 310.

It will be appreciated that installed security software 115 can, by way of example, receive (or cause the computer that it is installed on to receive) a protection module 125 from a protection modules server 105. In response to the received protection module, security software 115 can update a pre-installed protection module on the security software, including updating the processing module library and updating the module data library.

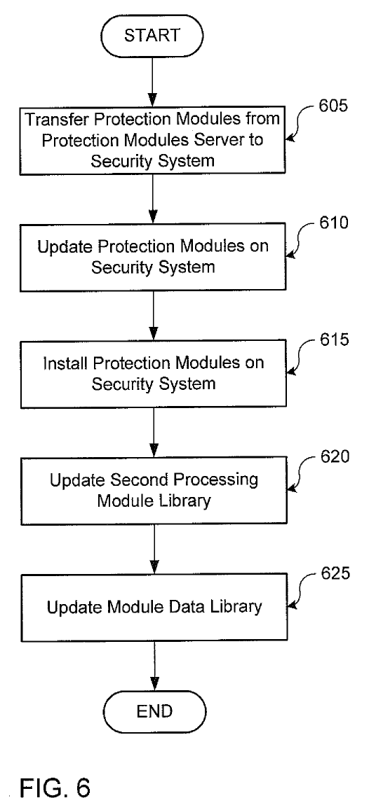

The following describes an example procedure for updating protection modules in a security system (or security software) 115, with reference to the flowchart shown in FIG. 6. In step 605 of FIG. 6, protection modules 125 are transferred from protection modules server 225 to the security software 115. Subsequently in step 610, the protection modules are updated on the security software 115. Protection module updater 305 is responsible for receiving protection modules from a protection modules server 225. The protection modules are transferred from the protection modules server 225, to the client computer system 110, and subsequently to the security software 115. In one embodiment, second subscription information 325 is read by the protection module updater 305 prior to receiving protection modules from the protection modules server 225. In this embodiment, the protection module updater 305 only receives protection modules from the protection modules server 225 if updates are allowed by the second subscription information 325.

Merely by way of example, the second subscription information 325 includes the expiry date of the annual subscription of a security software 115 to the protection modules update service. If the current date is before the expiry date, the protection module updater 305 receives protection module updates from a protection modules server 225. Otherwise, the protection module updater 305 does not receive protection module updates.

In verifying the permission to allow a security system (or security software) 115 to receive protection module updates, one of the following subscription scenarios may be used:
(i) Both the first subscription information 215 and second subscription information 325 is used.
(ii) Only the first subscription information 215 is used.
(iii) Only the second subscription information 325 is used.
(iv) Neither the first subscription information 215 nor the second subscription information 325 is used.

In one embodiment, security system (or security software) 115 is a running application and users of the security software may subscribe to the protection modules update service by paying an annual fee via a web page. Once the monetary transaction is cleared, either or both, first subscription information 215 and second subscription information 325 is updated with the new protection module update service expiry date. The expiry date may be applied to the security software 115 or the named user. The former is used when the licensing of security software 115 is on a per-machine basis, and the latter is used when the licensing of security software 115 is on a per-named-user basis. The above descriptions are based on a per-machine license, where a single security software 115 is installed on one computer system. However, other subscription methods are possible. The following licensing and subscription arrangements may be used:
(a) User purchases perpetual or annual license for security software system 115 on a per-machine basis, and subscriptions to protection modules are based on each security software system 115.
(b) User purchases perpetual or annual license for security software 115 on a named-user basis, and subscriptions to protection modules are based on each named-user.
(c) User purchases perpetual or annual license for security software 115 on a per-machine basis, and purchases perpetual licenses to one or more protection modules, which may or may not include future replacement protection modules.
(d) User purchases perpetual or annual license for security software 115 on a named-user basis, and purchases perpetual licenses to one or more protection modules, which may or may not include future replacement protection modules.

The subscription information provided by first subscription information 215 and second subscription information 325 may include:
(1) Subscription information: start date and time, expiry date and time, fee paid, and other conditions.
(2) Perpetual license information: purchase date, fee paid, and other conditions.
(3) Total number of licenses, that is, the number of computer systems or users covered.
(4) License keys.
(5) User details: name, address, email, phone number, fax number and other contact information.
(6) Company details: company name, address, phone number, fax number, web address and other contact information.

Note that the subscription information may include perpetual license information. In one embodiment, the subscription information is encrypted.

In step 615 of FIG. 6, each of the newly updated protection modules are installed on security software system 115. In step 620, the second processing module 130 provided in each protection module 125 is added to the second processing module library 315. In step 625, the module data provided in each protection module 125 are added to the module data library 316. Typically, each second processing module in the second processing module library 315 has a corresponding module data in the module data library 316.

Protection module installer 310 installs the newly updated protection modules by at least extracting the second processing module 130 from each protection module 125 and adding the second processing module 130 to the second processing module library 315. In one embodiment, the second processing module library 315 is a directory on a storage device, such as a hard disk. In this embodiment, a second processing module 125 is stored as a file in this directory. Merely by way of example, the protection module 125 may be a file comprising the second processing module 130 and module data 135. The protection module installer 310 extracts the second processing module 130 and saves it as a file in the directory designated as the second processing module library 315. Examples of other embodiments of the second processing module library 315 include an SQL database, MySQL database, PostgreSQL database, Oracle database, and a single file containing a collection of one or more second processing modules 130. Prior to adding second processing module 130 to the second processing module library 315, protection module installer 310 may modify the second processing module 130.

During the installation of a protection module 125, the protection module installer 310 also extracts the corresponding module data 135 from the protection module 125 and adds it to the module data library 316. In one embodiment, the module data library is a directory on a storage device, such as a hard disk. In this embodiment, module data 135 is stored as a file in this directory. Merely by way of example, the protection module 125 may be a file containing the second processing module 130 and module data 135. The protection module installer 310 extracts the module data 135 and saves it as a file in the directory designated as the module data library 316. Examples of other embodiments of the module data library 316 include an SQL database, MySQL database, PostgreSQL database, Oracle database and a single file containing a collection of one or more module data 135. This single file may be a binary/text representation of a data structure storing a collection of module data. Examples of such a data structure include, but not limited to, the list, tree, array and hash table data structures.

The term “supported processing component” is used to refer to a processing component that has a corresponding protection module available that can provide protection. Similarly, the term “supported application” is used to refer to an application that has a corresponding protection module available that can provide protection. Here, “application” may refer to a running application or the program associated with the application, where either, or both, may be valid depending on the usage context.

Examples of the information that may be contained in module data 135 include protection module version, versions of the processing component supported by the protection module, the name of the supported processing component, the filenames and paths of the files related to the operation of the supported processing component, the filename and path of the corresponding second processing module 130, digital signature of the corresponding second processing module 130, and other information required by the protection system 320 to provide protection for the supported processing component. Prior to adding module data 135 to the module data library 316, protection module installer 310 may modify the module data 135. Examples of this modification include changing the filename and path of the corresponding second processing module 130 to one that corresponds to the actual filename and path used on the client computer system 110, and changing the filenames and paths of the files related to the operation of the supported processing component to the actual ones used on the client computer system 110.

Files, libraries, modules and/or data related to the operation of processing components may be installed on the client computer system 110 before or after the installation of the corresponding protection module. If the supported processing component files, libraries, modules and/or data are installed after the corresponding protection module has been installed, then at least one of the corresponding second processing module 130 and module data 135 must be updated. For example, the filenames and paths of the newly installed files, libraries, modules and/or data need to be recorded in the corresponding module data 135. In this case, the protection module installer 310 may be configured to detect for processing component file, library, module and/or data installations and automatically updating the corresponding second processing module 130 and/or module data 135 if required. Note that other elements of the present invention may be configured to perform this functionality, such as the protection system 320, or the second processing module attacher 410 (shown in FIG. 4).

As an example on the Microsoft Windows XP operating system environment where processing components are running applications, protection module installer 310 may be configured to periodically check the registry for newly installed application files. The appropriate registry keys can be checked for newly installed applications that has a corresponding installed protection module. An example of a registry key that can be checked in this manner is “HKEY_LOCAL_MACHINE\SOFTWARE\Microsoft\Windows\CurrentVersion\Uninstall”. This key can be checked for the presence of an entry with the name of the supported application. The name of the supported application can be obtained from the corresponding data module 135. This name typically does not change whether or not an application is installed, but the filename and path to the executable file of the application may change, where in this case the executable file is the file related to the operation of the processing component. The filename and path to the executable file can be obtained from a sub-key of the above-mentioned registry key. The name of the application may also be obtained from a sub-key. For example, the filename and path may be obtained from the “DisplayIcon” sub-key, and the install directory may be obtained from the “InstallLocation” sub-key. Typically, there is enough information in the sub-keys to discover the correct filename and path to the executable file of the application. Another example of a registry location that can be checked for application paths is the “HKEY_LOCAL_MACHINE\SOFTWARE\Microsoft\Windows\CurrentVersion\AppPaths” location.

The files, libraries, modules and/or data related to the operation of processing components may be uninstalled from client computer system 110 where a corresponding protection module is installed. In one embodiment, the protection module installer 310 may be configured to detect the removal of files, libraries, modules and/or data related to the operation of supported processing components and update the corresponding second processing module 130 and/or module data 135 to indicate that the processing component files, libraries, modules and/or data are no longer available on the client computer system 110. The detection of the removal of files, libraries, modules and/or data may be performed by checking the registry as described above. The removal detection operation may be performed periodically. The removal detection operation may be automatic. Note that other elements of the present invention may be configured to perform this functionality, such as the protection system 320, or the second processing module attacher 410 (shown in FIG. 4).

It will be appreciated that a protection system 320 can use the second processing module library 315 and module data library 316 to provide protection for supported processing components.

FIG. 4 further illustrates an embodiment of a protection system (or software) 320.

In this embodiment, the security software comprises a first processing module 415 adapted to be executable on the client computer for receiving input data. Such that when the first processing module is executed, the input data is receivable by the first processing module prior to the input data being accessed by a first client module 445 of the client computer, and is subsequently intended for processing by the processing component 440. The first processing module 415 is adapted to encrypt (using an encryption engine 420) the input data and transfer the encrypted data to the client module 445; such that the encrypted data is accessible by the client module. An attached second processing module 425, as attached, is adapted to receive the encrypted data from the client module, decrypt the encrypted data (using a decryption engine 430) and transfer the decrypted data to the processing component 440.

It will be appreciated that the client module 445 can be predetermined by the security software, and can include any one or more of the set comprising:
(a) a message queue manageable by an operating system process of the client computer;
(b) a second processing component executable on the client computer;
(c) an input data handling process executable on the client computer; and
(d) an input and/or output data handling process executable on the client computer.

In this embodiment, the protection system 320 comprises second processing module attacher 410, first processing module 415, and attached second processing module 425. Input data source 405 transmits input data to the protection system 320. The first processing module 415 comprising encryption engine 420 receives the input data and produces encrypted input data using the encryption engine 420. The encrypted input data is passed on to the operating system plus other systems 445. Merely by way of example, the operating system in 445 includes message queues managed by operating system processes. Merely by way of example, other systems may include other running applications. The encrypted input data are decrypted by decryption engine 430, which is provided by attached second processing module 425. The decrypted input data are then transmitted to processing component 440. Merely by way of example, input data source 405 includes keyboards, mice, computer systems, protocol converters, scanners, other peripherals devices, processes, and threads. An example of a protocol converter is one that converts RS-232 signals to keyboard inputs via PS/2 or USB ports.

Malware 450 may also be present in the client computer system 110, which attempts to spy on data traversing the client computer system 110. However, typically, the points at which malware 450 are spying on comprise encrypted input data generated by the first processing module 415. Therefore, the possibility of malware 450 comprehending the spied data is mitigated. Malware 450 may also be a backdoor attempting to insert backdoor data destined for processing component 440, where the processing component 440 is a running application. However, typically, the points at which malware 45o attempts to insert data are points comprising encrypted input data that will be decrypted by decryption engine 430. Consequently, the decrypted backdoor data will not be comprehensible by the running application, because the backdoor data is not encrypted by the first processing module 415. Therefore, the possibility of malware 450 sending proper commands and data to the application is mitigated.

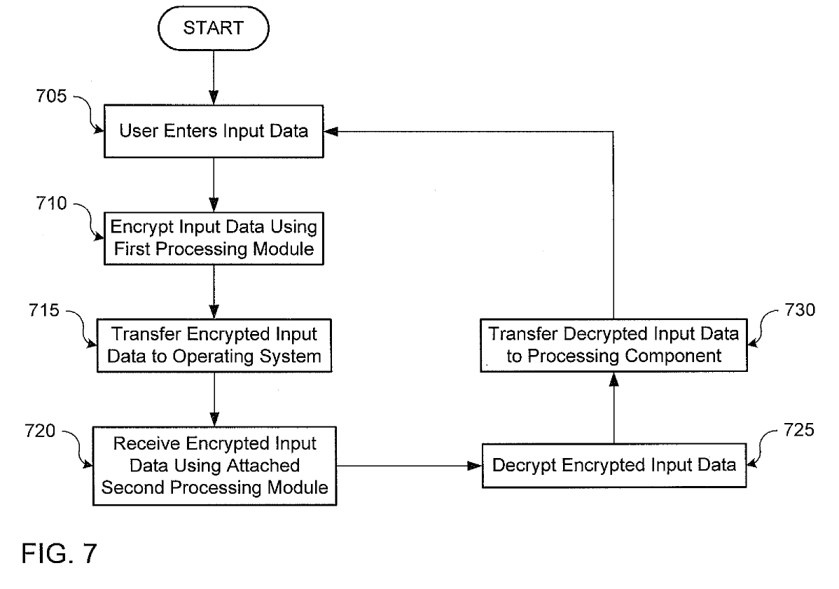

FIG. 7 depicts a flowchart outlining the steps involved in protecting input data from malware in one embodiment of the invention where a user supplies the input data. In step 705, a user enters input data. For example, the user may be entering input data into an input data source 405. The input data is then encrypted by the first processing module 415 in step 710. In step 715, the encrypted input data is transferred to the operating system. In step 720, the encrypted input data is received by the attached second processing module 425. The attached second processing module 425 subsequently decrypts the encrypted input data in step 725.

In step 730, the decrypted input data is transferred to the processing component 440. The procedure begins again at step 705. In some embodiments, users may enter the next input data as the previous input data is simultaneously encrypted, decrypted, traversed through the operating system and/or being delivered to the processing component.

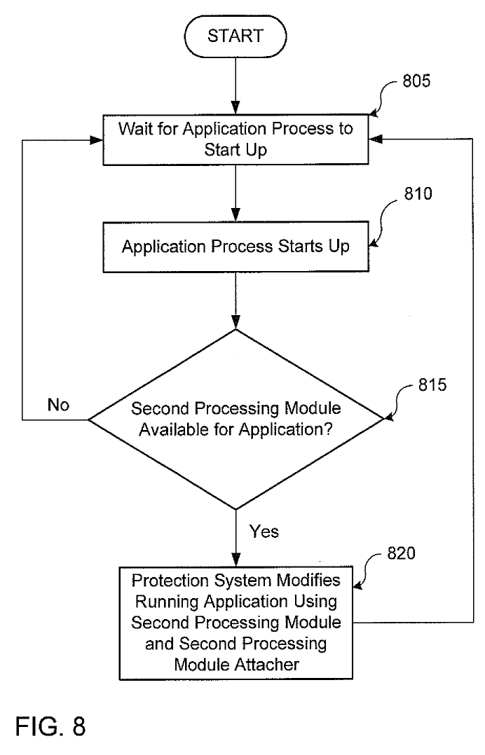

The following description of the operation of one embodiment of the present invention references the flowchart in FIG. 8. The flowchart illustrates the procedure of attaching a second processing module to a running process. In this embodiment, the processing component is a running application. Step 805 waits for an application process to start up. The application process is started up in step 810. Merely by way of example, the application may be started up by the user of the client computer system 110, a system event, a task scheduler, another running process, or some other system. In step 815, once an application process has started up, a check is performed to see if a second processing module 130 is available for this application. If a second processing module 130 is not available, then step 805 is taken to wait for another application to start up. If a second processing module 130 is available for the application, then step 820 modifies the running application using the second processing module attacher 410 by attaching the corresponding second processing module 130 to the running application.

Second processing module attacher 410 is responsible for checking the second processing module library 315 and module data library 316 to see if a second processing module 130 is available for a processing component. With reference to the embodiment used in FIG. 8, the processing component is a running application. When a user starts a software application, the second processing module attacher 410 reads the data in the module data library 316. If there exists module data 135 in module data library 316 that corresponds to a second processing module 130 supporting the application that just started up, then the second processing module attacher 410 proceeds to attach the corresponding second processing module 130 to the running application as indicated by the dashed arrow in FIG. 4, thereby to perform attach second processing module 490. The second processing module 130 thus attached to the running application is referred to as the attached second processing module 425. Typically, the attached second processing module 425 is attached to the processing component 440 via hook 435.

In one embodiment, the second processing module library 315 may be a directory of files, where each file is a second processing module 130. The module data library 316 may be a list data structure of entries, where each entry comprises module data 135. When stored in secondary storage, such as a hard disk, the list data structure may be a single file. During normal operation, the list data structure is stored in random access memory of the client computer system 110. When an application starts up, the second processing module attacher 410 traverses the list data structure to read each module data 135 to search for one that includes the correct name and version of the application that just started up. If the search returns a matched result, then the corresponding second processing module 130 is attached to the running application. If the search did not return a positive match, then the running application is not modified.

In one embodiment on the Microsoft Windows operating system environment, the second processing module 130 is stored in the second processing module library 315 as a dynamic link library (DLL) file. When the second processing module attacher 410 attaches the second processing module 130 to the running application, the DLL is injected into the running application. In one embodiment on the Linux operating system environment, the second processing module 130 may be stored as a shared library file with the “.so” file extension.

Hook 435 is a conceptual element that attaches the attached second processing module 425 to the processing component 440. In one embodiment, hook 435 is established by modifying operating system function calls. Processing component I/O handling functions include operating system I/O handling functions, so by intercepting operating system I/O handling functions the attached second processing module 425 is attached to the processing component. Merely by way of example on the Microsoft Windows operating system environment, the attachment of the attached second processing module 425 to the processing component 440 is achieved through intercepting Win32 API calls. If the second processing module 130 is implemented as a part of a DLL file as described above, then the Win32 API functions may be intercepted after the DLL is injected into the running application. After the DLL injection operation, the second processing module 130 executes within the process space of the running application. The appropriate Win32 API functions may then be intercepted by modifying the machine instructions of those functions. Trampoline functions may be used to access the original functions corresponding to the modified Win32 API functions.

Suppose the input data from input data source 405 are keystroke data and the input data source 405 is a keyboard. In this example, the Microsoft Windows Win32 API function PeekMessageA, may be modified so that when this Win32 API function is called by the running application, a corresponding replacement function in the attached second processing module 425, say HookPeekMessageA, is called instead. This HookPeekMessageA replacement function may then perform the following operations:
(I) Call the PeekMessageA trampoline function, and thus effectively calling the original operating system PeekMessageA function.
(II) Decrypt the keystroke data as contained in the LPMSG structure.
(III) Return the decrypted keystroke data in the LPMSG structure.

The results of the HookPeekMessageA function are then returned to the processing component 440 containing the decrypted input data.

The modification of operating system I/O handling functions for one running application does not affect the I/O handling functions of other running applications. Operating system I/O handling functions are normally shared between different running applications, but when modification is performed, a “copy-on-write”, or similar, operation can be carried out where a copy of the operating system I/O handling functions is made for the running application performing the modification. Therefore, the running application performing the modification obtains its own copy of the operating system I/O handling functions and other running applications are not affected.

A single attached second processing module 425 may require the modification of a plurality of operating system functions to establish the hook 435. Furthermore, within each replacement function provided by the attached second processing module 425, calls can be made to the trampoline function before and/or after the decryption of the encrypted input data.

In one embodiment, attached second processing module 425 may communicate control data to and from first processing module 415. Merely by way of example, the attached second processing module 425 synchronises with the first processing module 415 to ensure that data encrypted in encryption engine 420 can be decrypted in decryption engine 430. This may involve the exchange of one or more encryption keys and parameters, which may include parameters for generating cryptographically strong random numbers. Therefore, control data includes, but not limited to, encryption keys, encryption parameters, encryption-decryption sequence data, initialisation vectors, start signals, stop signals and pause signals. Encryption-decryption sequence data may be used in one-time pad encryption to maintain synchronisation between encryption engine 420 and decryption engine 430. Merely by way of example, encryption-decryption sequence data may be sent from encryption engine 420 to decryption engine 430 by inserting sequence data into its output stream of encrypted input data. The decryption engine 430 then extracts the sequence data and accordingly synchronises itself to decrypt the incoming stream of encrypted input data.

In one embodiment, encryption engine 420 and decryption engine 430 may perform one-time pad encryption and decryption respectively. Other embodiments is of the encryption engine 420 and decryption engine 430 may include them operating together to perform public-key cryptography, SPKI encryption/decryption, or PKI encryption/decryption. These encryption schemes may be used in addition to the use of one-time pad encryption/decryption to securely establish session keys and random number generation parameters, such as seeds.

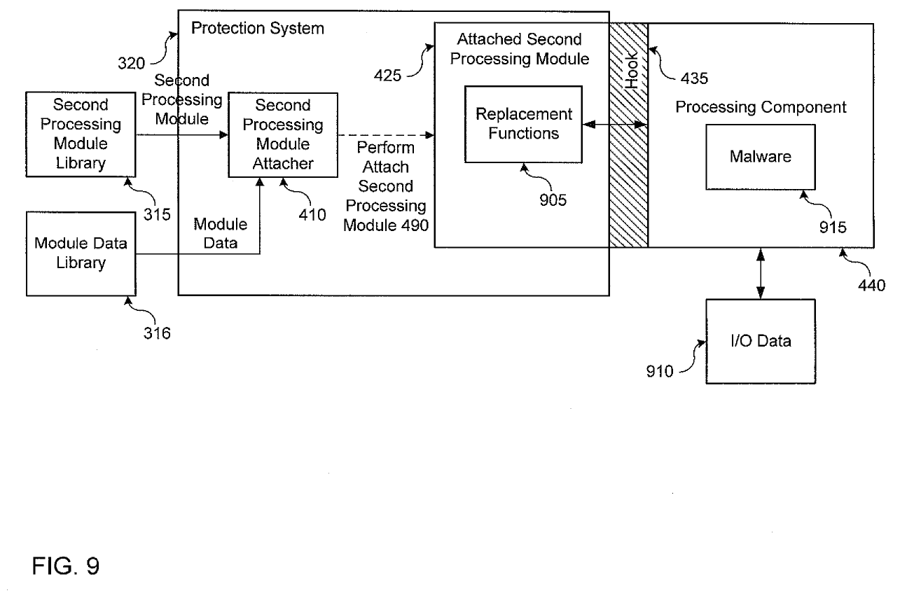

FIGS. 9 through 13 further illustrate, by way of example only, alternative embodiments of a protection system or software 320. In these embodiments a processing module comprises at least one replacement function (for example 905, 1005, 1105, 1205, and 1310). When the processing module is attached to the processing component, the replacement function is executed when a respective function associated with execution of the processing component would otherwise be called for execution, thereby enabling enforcement of a security policy governing access to a client computer resource and/or data element.

By way of example only, the replacement function is selected from the set comprising:
(a) an input handling function of the processing component;
(b) an output handling function of the processing component; and
(c) a file system function of the operating system.

The replacement function can further comprise at least one pattern matcher to categorize data processed by the processing component.

The replacement function can be controlled by an administration server, and wherein the replacement function is coupleable to the administration server via a transmission medium.

The replacement function can retrieve information from a processing server for assisting processing by the replacement function, and wherein the replacement function is coupleable to the processing server via a transmission medium.

FIG. 9 further illustrates an embodiment of the protection system 320. In this embodiment, the attached second processing module 425 comprises one or more replacement functions 905. The replacement functions are called when a corresponding I/O handling function of the processing component is called, where the processing component 440 receives or transmits I/O data 910. The original I/O handling functions of the processing component may optionally be called during processing within the replacement functions 905.

Merely by way of example, a processing component may be infected with malware 915, which attempts to transmit sensitive data to another computer system via network ports. In one embodiment, replacement functions for network-related I/O handling operations are called every time a transmit/receive attempt is made on the network ports. The replacement functions may then block the transmit/receive operation. For example, the processing component may be a process running the Microsoft Notepad application. Since there is no need for the Notepad application to send an email via the SMTP protocol, a second processing module attached to the Notepad application may block all SMTP related network traffic for this application. Any input or output network data operations for any processing component may be filtered in this manner.

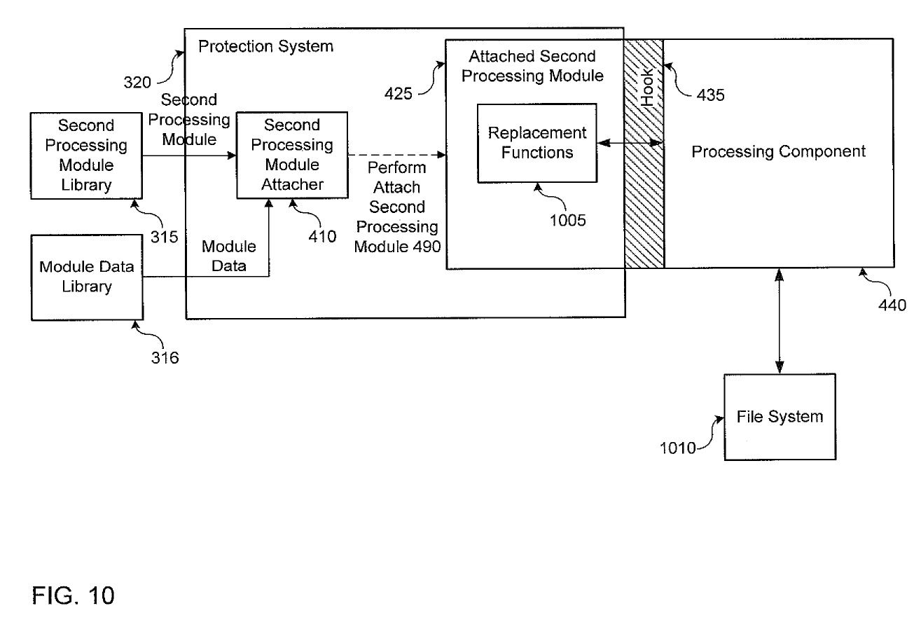

FIG. 10 further illustrates one embodiment of the protection system 320. The attached second processing module 425 comprises one or more replacement functions 1005, which are called when an operation with the file system 1010 occurs. In one embodiment, the replacement functions encrypt data as a file is written, and decrypt as file data is read. In this manner, the attached second processing module provides automatic file encryption/decryption. In another embodiment, the replacement functions 1005 operate to filter the files that can be operated on by the processing component 440. Merely by way of example, the replacement functions 1005 may restrict the files to those stored on the local machine that does not contain operating system files. For example, accesses to files stored on a network drive and the “C:\WINDOWS” directory are disallowed. In another example, accesses to a peripheral device, such as a USB drive are also disallowed. In general, finer grain control may also be provided by the replacement functions. For example, accesses to particular directory in a USB drive are allowed and only certain files are allowed to be read/written from/to the USB drive.

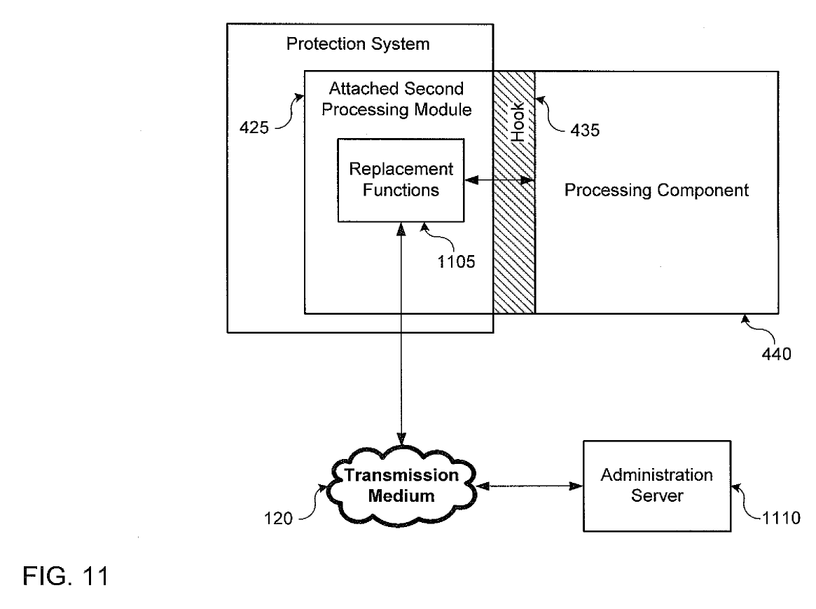

Replacement functions may be created that allow finer grain control of policies that affect how processing components process I/O data. The control of the policies may also be changed via a controller by an administrator. FIG. 11 illustrates one embodiment of the present invention where the policies enforced by replacement function 1105 can be controlled by an administration server 1110, where the administration server 1110 is coupled to replacement functions 1105 via transmission is medium 120. The control of the policies is managed by the administration server 1110.

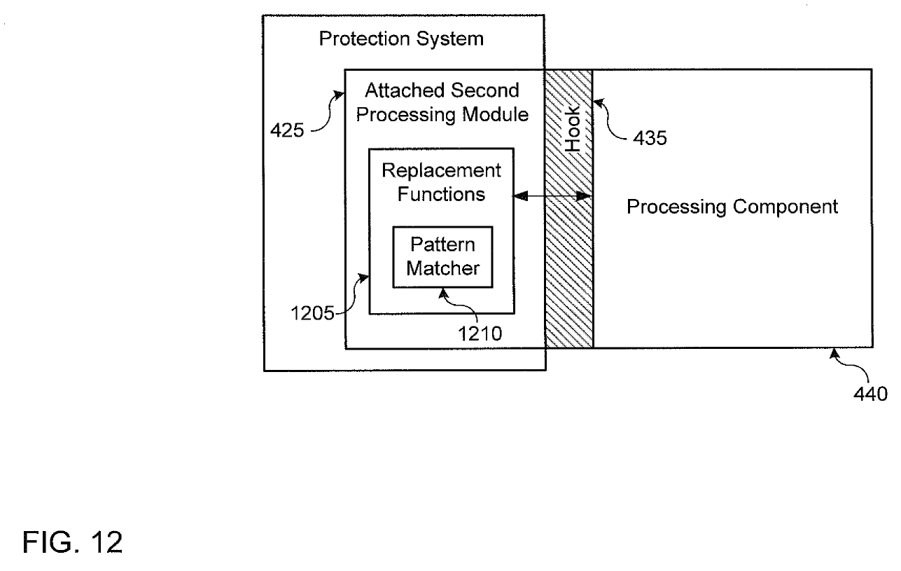

FIG. 12 further illustrates one embodiment of the protection system 320. Replacement functions 1205 comprise one or more pattern matchers 1210. The replacement functions monitor I/O data being processed by processing component 440 using pattern matcher 1210. In one embodiment, the pattern matcher looks for data of interest, such as sensitive corporate data or identifying traits or properties of malware. Matched data automatically triggers an action that may involve notifying a user, logging information, quarantining the processing component, terminating the processing component, or setting one or more flags to indicate the occurrence of an event. In one embodiment, the pattern matcher 1210 is a regular expression pattern matcher. Merely by way of example, the pattern matcher 1210 examines keystrokes as they are typed to search for text that matches a database of patterns.

In one embodiment, the processing component 440 is potential malware. The corresponding attached second processing module restricts the I/O operations that can be performed by this malware.

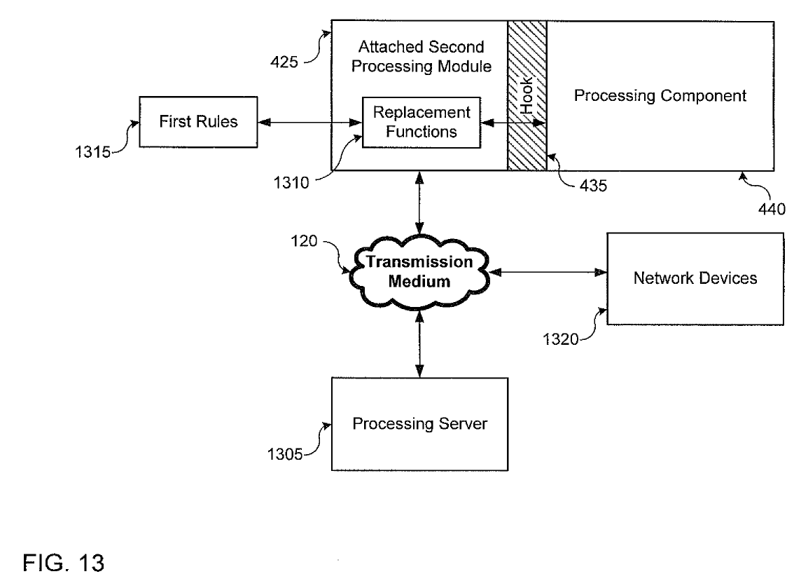

FIG. 13 further illustrates one embodiment of the protection system 320. In this embodiment, the attached second processing module 425 is coupled to a processing server 1305 via a transmission medium 120. The attached second processing module 425 comprises replacement functions 1310. The replacement functions 1310 are executed when selected I/O processing functions are called by processing component 440. When a replacement function is operating, it may check a processing server 1305 to retrieve information that is used to assist processing in the replacement function. In general, the execution of the replacement functions may include calling subroutines provided by attached second processing module 425.

Merely by way of example, the processing server 1305 maintains information on the reputation of network devices 1320. Network devices 1320 include computers, handheld computing devices, portable notebook computers, portable devices, appliances, and servers. Network devices 1320 may be located, addressed and communicated with via their IP address, which may be dynamic or static, and the IP address may be IPv4 or IPv6. Other forms of locating, addressing and communicating with network devices 1320 may be used.

The reputation maintained by processing server 1305 may be used to identify suspicious network devices 1320 that have been, being, or going to be used for malicious purposes, such as sending out spam, propagating viruses and worms, and phishing attacks. When processing component 440 attempts to perform an I/O operation, such as one involving communications with one of the said network devices, via transmission medium 120, the attached second processing module 425 communicates with processing server 1305 to verify whether the network device being communicated with is a suspicious network device. If the network device is suspicious, then the attached second processing module 425 may choose to disallow communications between the processing component 440 and the network device.

First rules 1315 may also be used by the replacement functions 1310. The first rules 1315 may include policies that determine whether and which communications between processing component 440 and network devices 1320 are allowed. For example, first rules 1315 may include rules that always allow communications with network devices 1320 within an organization's network. For example, first rules 1315 may state specifically the network devices 1320 that may communicate with processing component 440. In one embodiment, first rules 1315 may be provided by processing server 1305.

In another example, the processing server 1305 maintains information on the network devices 1320 that may communicate with processing component 440. This may be used to enforce policies on resource usage by a particular processing component 440 for a particular user. For example, all processing components 440 being used by one user on a computer system may be allowed access to the network printer, but all processing components 440 being used by another user may be disallowed access to the same network printer. In another example, some processing components 440 being used by one user may access a particular network resource, but other processing components 440 are disallowed access. For example, a running instance of the Microsoft Visual Studio code development environment executed by one user is allowed access to a network file server, where the processing component 440 is the running instance of the Microsoft Visual Studio program. However, a running instance of Microsoft Internet Explorer executed by the same user is not allowed access to the same network file server.

In one embodiment, processing server 1305 may reside on the same computer system as the attached processing module 425.

In one embodiment, the transfer of protection modules 125, its installation by the protection module installer 310, the installation of the second processing modules 130 in second processing module library 315, and the installation of module data 135 in module data library 316 is performed automatically without requiring intervention from a user on the security system 115. The automatic transfer and installation of protection modules 125 may occur on a regular basis where the transfer may be initiated by the protection modules server 225 or the protection module updater 305. The regularity of the transfer and/or installation may be set at the protection modules server 225, or set at the protection module updater 305 by a user of the security system 115. In some embodiments, the transfer and installation of protection modules 125 may happen at different times and at different regularities on different security systems 115.

The applicant envisages that the invention will have a wide range of applications, for example, for use in securing data and I/O operations in: web browsers; Internet chat applications; e-mail applications; word processors; the entering of usernames and passwords; applications that handle credit card details; web services; applications that use network communication; and applications that process I/O data and other information. This invention is also applicable to securing the input of mouse movements and button presses, and the input of user data using other physical devices. This invention is also applicable to protecting users from backdoor attacks that exploit the input of keystrokes, mouse movements and button presses, and the input of user data using other devices. This invention is also applicable in restricting applications from accessing the network or other peripheral devices. This invention is also applicable in enforcing policies for accessing resources by applications.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### Interpretation

It will be appreciated that the following terms and associated definitions are used herein. These terms and associated definitions include:
Spyware—malware designed to secretly record data on a user's computer system and also typically deliver the recorded data to the attacker at some point in time.
Backdoor—malware designed to provide an attacker remote access to a user's computer system. Typically, via the backdoor, the attacker can execute commands on the user's computer or control the computer to some degree. It is possible that an attacker has full control of the computer via the backdoor.
Input data—data received by a system or sub-system from another system or sub-system. It includes data generated by an input source, such as an input device, through the interaction between a user/external system and the input device. Merely by way of example, input source includes keyboards, mice, computer systems, protocol converters, scanners, other peripheral devices, processes, and threads. An example of a protocol converter is one that converts RS-232 signals to keyboard inputs via PS/2 or USB ports.
Actor—a user, internal or external system that interacts with the input device.
Output data—data generated by a system or sub-system, which may be transmitted to another system or sub-system.
Program—instructions for a computer. The program may be in executable form or in source code form.
Process—(noun) means an executing program. In places where there may be confusion with the verb, process, and/or the alternative (noun) meaning of the word describing an action or operation, the term “running process” is used to refer to the meaning of the word process as defined here. Where the intended meaning is clear from the usage context the word, process, may still be used to mean running process. Examples of a running process can include, without limitation:
   an executing application (also referred to as a “running application”, “active application”, or a running instance of an application). Depending on usage context, “application” may be used to mean a “running application” or the program associated with the application. The intended meaning should be clear from the context in which it is used. Note that a single application may be executed by a plurality of running processes; and
   an executing operating system program.
Running process—see process.
Application process—an executing application. Also see process.
Operating system process—an executing operating system program. Also see process.
Processing component—a data destination, window, application, process or thread that has the ability to receive input data, process data and/or generate output data. Examples of application processing components include, without limitation:
   a Web browser application;
   a word processor application;
   a spreadsheet application;
   an e-mail client application;
   a command line shell application, such as “cmd.exe” (Windows) or “/bin/sh” (Linux);
   an SSH client application;
   a telnet application;
   an FTP client application;
   a client application;
   a server application;
   a stand-alone application;
   a networked application;
   a graphics application;
   a multimedia-type application;
   a presentation-type application;
   a note-taking software application;
   a source code editing application;
   a password management application;
   a games application;
   a text editing application;
   an application having the ability to receive input data;
   an application having the ability to process data;
   an application having the ability to generate output data; and
   custom applications.
   Examples of window, process and thread processing components include running instances and related data of the applications listed above.
Security system—the system disclosed herein to provide protection for processing components from malware.
Protection module—a component used by the security system (or security software) to protect a processing component.
Transmission medium—a medium used for the transmission of data and/or to connect two distinct processing components. Examples include the Internet, local area network, wireless network, wide area network, metropolitan area network, null-modem connection, PCI bus, HyperTransport bus, and a computer's internal data bus.

A computer systems typically includes:
Input sources, such as keyboard, mouse, and other input devices. An actor interacts with the input device, which converts the interactions into input data that can be further processed by the computer system where the input data is delivered to a processing component;
Output destinations, such as computer systems on a connected network, communication ports, file systems, and attached peripherals; and
A plurality of processing components, including those provided by the computer system's operating system.

A processing component typically has one or more data handling functions. A data handling function may be an input handling function, output handling function, or a processing function.

An input handling function is designed to receive and process input data. Processing component input handling functions include the computer system's operating system's input handling functions. For example, a running process typically processes input data by calling one or more operating system input handling functions. Since these operating system functions are executed by the running process, these functions can be considered to be a part of the running processes' input handling functions. A running application may be associated with one or more running processes.

An output handling function is designed to output data to one or more processing components, which may be transmitted via one or more transmission mediums. Examples of output handling functions include functions that save output data to a storage medium, such as a hard disk, send output data to another processing component via a network port, send output data to another processing component using the system bus, and display data on a computer display screen.

Processing functions include functions designed to transform a received data to another form. Merely by way of example, a processing function may be a function that converts ASCII-encoded to Unicode-encoded text. For example, a processing function may also be considered as the combination of an input handling function and an output handling function where the processing function receives and outputs data from and to the same processing component.

Input and output handling functions are also collectively herein referred to as I/O handling functions. I/O handling functions also include processing functions.

It would be appreciated that, some of the embodiments are described herein as a method or combination of elements of a method that can be implemented by a processor reading the memory of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

A software application can comprise executable code on a physical medium or transmitted electronically for carrying out one or more predetermined operations on a computer (or processing platform). A software application can typically be represented as software/source code written in one or more programming languages. A software application can also be embodied in machine executable code for carrying out one or more predetermined operations on a computer (or processing platform). A software application can also comprise executable code—or instructions—that when executed by at least one processors, further utilises firmware and/or hardware of the computer to carry out the predetermined operations. A software application can also be embodied in a computer-readable carrier medium, wherein the software is stored as data indicative of source code, machine executable code, or an intermediate form; such that the stored data can enable a computer (or processing platform) to carry out one or more predetermined operations. It will be appreciated that a machine executable form is typically derived from source code being applied to a ‘compiler’ and/or ‘assembler’ and/or ‘linker’, and can result in a plurality of intermediate forms. It will be further appreciated that a machine executable form can comprise many embodiments that include, by way of example only and without limitation: a sequence of machine code instructions for instructing a processor to carry out a predetermined operation, and/or a logic gates configuration adapted to enable a processing platform (for example a FPGA) to carry out a predetermined operation. It will also be appreciated that to carry out one or more predetermined operations the software application may require operation of a processor and/or hardware.

In programming methodologies, to ‘attach’ a processing module to a processing component—whether software or hardware—includes an aspect where the attached processing module executes (or operates) in series or parallel with respect to specific execution (or operation) of the software or hardware processing component. A ‘hook’ can be provided in the software or hardware component to simplify an attachment. By way of example only, a processing component in the form of a software function can be used to perform specific computation on input data, where a hook is used to specify the function to execute. In this example, by setting the hook a replacement function can be executed (or called), such that the replacement function is executed in-place-of the original function. It will be appreciated that execution of the replacement function may further call for the execution of the original function. It will be further appreciated that data processed by a processing component can include any one or more of the set comprising input data, intermediate data, transitional data, and output data. Preferably an attached module (or function) can execute in conjunction with—and/or within the same process space as—the processing module to which it is attached.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

The reference to any prior art in this specification is not, and should not be taken as, an acknowledgment or any form of suggestion that that prior art forms part of the common general knowledge.

What is claimed is:

1. A method for improving computer security, the method causing a computer to execute instructions for protecting a processing component on itself the method comprising steps for:
generating a second processing module attacher adapted to be responsive to an execution of the processing component;
storing data indicative of at least one second processing module thereby to define a processing module library;
wherein the attacher is adapted to retrieve a second processing module from the processing module library in response to the execution of the processing component;
wherein the attacher is further adapted to attach a retrieved second processing module to the processing component, thereby to enable a security restriction on data processed by the processing component.

2. The method of claim 1, wherein:
the retrieved second processing module is adapted to be executable within a process space of, and in conjunction with, the processing component when attached, thereby enabling enforcement of a security policy governing access to a client computer resource.

3. The method of claim 1, wherein:
the first processing module is adapted to be executable on a client computer for receiving input data, such that when the first processing module is executed, the input data is receivable prior to the input data being accessed by a first client module of the client computer and is subsequently intended for processing by the processing component;
wherein the first processing module is adapted to encrypt the input data and generate encrypted data and transfer the encrypted data to the client module; such that the encrypted data is accessible by the client module;
wherein the second processing module, when attached, is adapted to receive the encrypted data from the client module, decrypt the encrypted data and generate decrypted data and transfer the decrypted data to the processing component.

4. The method of claim 3, wherein:
the client module is predetermined by the instructions, and includes any one or more of:
(a) a message queue manageable by an operating system process of the client computer;
(b) a second processing component executable on the client computer;
(c) an input data handling process executable on the client computer; and
(d) an input and/or output data handling process executable on the client computer.

5. The method of claim 1, wherein:
the second processing module comprises at least one replacement function;
such that, when the second processing module is attached to the processing component, the replacement function is executed when a respective function associated with execution of the processing component would otherwise be called for execution, thereby enabling enforcement of a security policy governing access to a client computer resource.

6. The method of claim 5, wherein the replacement function is selected from the set comprising:
(a) an input handling function of the processing component;
(b) an output handling function of the processing component; and
(c) a file system function of the operating system.

7. The method of claim 5, wherein the replacement function further comprises:
at least one pattern matcher to categorize data processed by the processing component.

8. The method of claim 5, wherein:
the replacement function is adapted to be controlled by an administration server, and wherein the replacement function is coupleable to the administration server via a transmission medium.

9. The method of claim 5, wherein:
the replacement function is adapted to retrieve information from a processing server for assisting processing by the replacement function, and wherein the replacement function is coupleable to the processing server via a transmission medium.

10. The method of claim 1, further comprising steps stored in a memory for:
implementing a protection module installer adapted to receive a protection module including data indicative of a processing module and module data;
wherein the module installer is further adapted to store the data indicative of a processing module in the processing module library; and store the data indicative of module data in a module data library.

11. The method of claim 10, further comprising steps stored in a memory for:
implementing a protection module updater adapted to receive the protection module from a protection modules server via a transmission medium;
wherein the protection module updater is further adapted to transfer the protection module data to the protection module installer.

12. A method of protecting a processing component on a client computer, the method comprising the steps of:
retrieving, in response to program execution of the processing component, at least one second processing module from a processing module library; and
attaching the retrieved second processing module to the processing component, thereby to enable security restrictions to data processed by the processing component.

13. The method according to claim 12, further comprising the steps of:
receiving input data for the processing component prior to the input data being accessed by a first client module of the client computer;
encrypting the data; and
transferring the encrypted data to the first client module, such that the encrypted data is accessible by the first client module;
wherein the second processing module, when attached, is adapted to receive the encrypted data from the first client module, decrypt the encrypted data and transfer the decrypted data to the processing component.

14. The method according to claim 12, further comprising the step of:
providing at least one replacement function to the processing component;
such that, when the second processing module is attached to the processing component, the replacement function is executed when a respective function associated with execution of the processing component would otherwise be called for execution, thereby enabling enforcement of a security policy governing access to a client computer resource and/or data element.

15. The method according to claim 14, further comprising the step of:
providing at least one pattern matcher to categorize data processed by the processing component.

16. The method according to claim 14, further comprising the step of:
receiving control data for the replacement function from an administration server, wherein the replacement function is adapted to be coupleable to the administration server via a transmission medium.

17. The method according to claim 14, further comprising the step of:
retrieving information for the replacement function from a processing server to assist processing by the replacement function, wherein the replacement function is adapted to be coupleable to the processing server via a transmission medium.

18. A computer-readable medium carrying a set of instructions that when executed by one or more processors cause the one or more processors to carry out a method of protecting a processing component on a client computer, the method comprising the steps of:
retrieving, in response to program execution of the processing component, at least one second processing module from a processing module library; and
attaching the retrieved second processing module to the processing component, thereby to apply enable security restrictions to data processed by the processing component.

19. The computer-readable medium according to claim 18, the method further comprising the steps of:
receiving input data for the processing component prior to the input data being accessed by a first client module of the client computer;
encrypting the data; and
transferring the encrypted data to the first client module, such that the encrypted data is accessed by the first client module;
wherein the second processing module, when attached, is adapted to receive the encrypted data from the first client module, decrypt the encrypted data and transfer the decrypted data to the processing component.

20. The computer-readable medium according to claim 18, the method further comprising the step of:
providing at least one replacement function to the processing component;
such that, when the second processing module is attached to the processing component, the replacement function is executed when a respective function associated with execution of the processing component would otherwise be called for execution, thereby enabling enforcement of a security policy governing access to a client computer resource and/or data element.
